(19) United States
(12) Patent Application Publication
(10) Pub. No.: US 2021/0138770 A1
(43) Pub. Date: May 13, 2021

(54) SURFACE PROTECTIVE FILM

(71) Applicants: BANDO CHEMICAL INDUSTRIES, LTD., Hyogo (JP); WACOM CO., LTD., Saitama (JP)

(72) Inventors: Yutaka KAMADA, Hyogo (JP); Kazumi SAKANO, Hyogo (JP); Toshihiko HORIE, Saitama (JP); Soh KATO, Saitama (JP)

(73) Assignees: BANDO CHEMICAL INDUSTRIES, LTD., Hyogo (JP); WACOM CO., LTD., Saitama (JP)

(21) Appl. No.: 16/618,164

(22) PCT Filed: May 30, 2018
(86) PCT No.: PCT/JP2018/020632

§ 371 Date: Nov. 29, 2019

(30) Foreign Application Priority Data
May 31, 2017 (JP) 2017-107531

(51) Int. Cl. B32B 27/08; C09J 7/29; B32B 27/40; B32B 7/12; B32B 37/00; B32B 37/15; G02B 1/14

(52) U.S. Cl. CPC B32B 27/08; C09J 7/29; B32B 27/40; B32B 7/12; B32B 2307/42; B32B 37/153; G02B 1/14; C09J 2475/006; B32B 2307/412; B32B 37/0053

(57) ABSTRACT

The present invention addresses the problem of providing a surface protective film that makes it possible to cut blue light and has exceptional durability. As a solution, the present invention provides a surface protective film in which at least four layers comprising a protective layer made of polyurethane, a transparent substrate film, a blue light cutting layer, and an adhesive layer are laminated in the stated order.

### TECHNICAL FIELD

The present invention relates to a surface protection film for protecting a transparent substrate on a surface of a display.

### BACKGROUND ART

In electronic devices including displays such as smartphones, tablet type PCs, portable music players, and the like, in order to protect transparent substrates which are surfaces of the displays, surface protection films are attached thereto in many cases. Surface protection films are required to have light transmittance, scratch resistance, weather resistance, plasticizer resistance, antifouling properties, and the like. Furthermore, in recent years, these electronic devices have generally been operated using capacitive touch panels, and there are new requirements for the writing sensation of a touch pen, slipperiness, self-repairing properties in which a film pressed with a tip of a touch pen returns to its original state over time, and the like.

As such surface protection films, for example, the present applicants propose, as in Patent Literature 1, a surface protection film obtained by laminating three layers, i.e., a protective layer including a thermosetting polyurethane which is a cured product of a polyether polyol, an aliphatic isocyanate, an alcohol-based curing agent, and a non-amine catalyst, a transparent base film, and an adhesive layer in this order, and as in Patent Literature 2, a surface protection film obtained by laminating three layers, i.e., a protective layer made of polycarbonate-based polyurethane, a transparent base film, and an adhesive layer in this order.

Here, in the above-mentioned electronic devices, LEDs with a small amount of power consumption are generally used as a light source of a display. However, LEDs emit light having high energy among visible rays and having a wavelength of 380 nm or more and 500 nm or less which is assumed to be harmful to the eyes, that is, so-called blue light. It has been pointed out that continually gazing at light containing blue light for a long time may cause eye fatigue, decreased visual acuity, dry eyes, age-related macular degeneration, sleep disorders, and the like.

As methods for cutting out blue light emitted from displays, methods for bonding blue light cut films to surfaces of displays have been proposed. Blue light cut films cut out blue light using blue light cutting layers formed by applying and curing resin compositions containing yellow-based pigments which absorb blue light and fluorescent whitening agents which absorb blue light and emit longer wavelength light (refer to Patent Literature 3 and 4).

The present inventors have found a problem in which, when protective layers made of the polyurethanes proposed in Patent Literature 1 and 2 are directly formed above blue light cutting layers, they cannot be used for a surface protection film through which high visibility is required because fine air bubbles are generated in the protective layers, which adhere to the surfaces of the displays and the present invention to solve this problem has thereby been completed.

### REFERENCE LIST

### Patent Literature

Patent Literature 1: PCT International Publication No. WO 2017/094480

Patent Literature 2: PCT International Publication No. WO 2018/038069

Patent Literature 3: Japanese Patent Laid-Open No 2014-170082

Patent Literature 4: Japanese Patent Laid-Open No 2016-88979

### SUMMARY

### Technical Problem

An objective of the present invention is to provide a surface protection film capable of cutting out blue light and having excellent durability.

### Solution to Problem

The configuration of the present invention for accomplishing the above-described objective is as follows.

1. A surface protection film includes: at least four layers, i.e., a protective layer made of a polyurethane, a transparent base film, a blue light cutting layer, and an adhesive layer laminated in this order.

2. In the surface protection film as set forth in 1, the polyurethane is a polycarbonate-based polyurethane.

3. In the surface protection film as set forth in 1 or 2, the polyurethane is a cured product of a material composition which contains a polycarbonate-based polyol, an isocyanate, and an alcohol-based curing agent.

4. In the surface protection film as set forth in any one of 1 to 3, the protective layer has a dynamic friction coefficient of 0.10 or more and 0.26 or less with respect to a touch pen made of a polyacetal resin (POM) and having a hemispherical tip shape with a diameter of 1.4 mm.

5. In the surface protection film as set forth in any one of 1 to 4, the polyurethane contains a silicone-based additive.

6. In the surface protection film as set forth in any one of 1 to 5, the protective layer has a thickness of 50 μm or more and 300 μm or less.

7. A surface protection film laminate includes: a mold release film laminated on a surface of the surface protection film as set forth in any one of 1 to 6 on the protective layer side; and a release film laminated on a surface thereof on the adhesive layer side.

8. A method for producing a surface protection film having at least four layers, i.e., a protective layer made of a polyurethane, a transparent base film, a blue light cutting layer, and an adhesive layer laminated in this order includes: pouring a material composition into a gap between first and second gap holding members sent out using pair of rolls spaced apart from each other; thermally curing the material composition while the material composition is being held between the first and second gap holding members to produce the protective layer; and one of the first and second gap holding members is at least the transparent base film.

9. In the method for producing a surface protection film set forth in 8, one of the first and second gap holding members as a transparent base film has a blue light cutting layer.

10. In the method for producing a surface protection film set forth in 8 or 9, the polyurethane is a polycarbonate-based polyurethane.

11. In the method for producing a surface protection film set forth in any one of 8 to 10, the material composition includes a silicone-based additive.

### Advantageous Effects of Invention

In the surface protection film of the present invention, since at least a transparent base film is disposed between the protective layer made of a polyurethane and the blue light cutting layer, the protective layer is not in contact with the blue light cutting layer. For this reason, in the surface protection film of the present invention, fine air bubbles resulting from the reaction between isocyanates and moisture are not generated in the protective layer and the optical characteristics and visibility required for the surface protection film are obtained. The surface protection film of the present invention has excellent adhesion between neighboring layers and delamination does not occur even if used over a long period of time. Furthermore, the surface protection film of the present invention has excellent light transmittance, scratch resistance, weather resistance, and self-repairability.

Since the surface protection film of the present invention includes the blue light cutting layer, since adverse effects on the eyes due to blue light is small, even when continually viewing a display to which the surface protective film is attached for a long time, the eyes become less tired. The surface protection film of the present invention can cut out blue light which is harmful to the eyes and allows an excellent writing sensation with a touch pen. For this reason, the surface protection film of the present invention can be appropriately used for electronic devices which operate using drawing with a touch pen while viewing a screen for a long time such as pen tablets for drawing, electronic books, electronic textbooks, and electronic notebooks, and the like.

The surface protection film utilizing a polycarbonate-based polyurethane as a polyurethane has excellent plasticizer resistance and it is difficult for discoloration, expansion, or the like to occur in the surface protection film because a plasticizer does not easily penetrate into the surface protection film even if it comes into contact with rubber products or plastic products.

The surface protection film of the present invention has optical characteristics such that the surface protection film can be used even though the protective layer has a thickness of 50 μm or more and 300 μm or less. Furthermore, since the surface protection film has a thickness of 50 μm or more and 300 μm or less, the writing sensation and the slipperiness with a touch pen are very good and the self-repairability is excellent. In addition, since the surface protection film of the present invention contains a silicone-based additive, the slipperiness is improved and it is possible to very comfortably perform a touch panel operation using a touch pen, a finger, or the like.

The surface protection film laminate obtained by laminating a mold release film and a release film on the surface protection film of the present invention has a protective layer and an adhesive layer which are protected and excellent handleability.

It is possible to continuously produce the surface protection film using the production method of the present invention. Furthermore, it is possible to produce the protective layer having a thickness of 50 μm or more and 300 μm or less which is difficult to be produced using a wet coating method without optical characteristics deteriorating. In addition, it is possible to easily form unevenness in a surface of a protective layer using a transfer method.

### BRIEF DESCRIPTION OF THE DRAWINGS

FIG. 1 is a diagram illustrating a surface protection film according to an embodiment of the present invention.

FIG. 2 is a diagram illustrating a state in which the surface protection film according to the embodiment of the present invention is adhered to a transparent substrate of a surface of a display.

FIG. 3 is a diagram illustrating a surface protection film laminate.

FIG. 4 is a diagram illustrating a method for producing a protective layer of the surface protection film.

### REFERENCE SIGNS LIST

1 Protective layer
2 Transparent base film
3 Blue light cutting layer
4 Adhesive layer
5 Mold release film
6 Release film
10 Surface protection film
20 Transparent substrate
30 Surface protection film laminate
40 Sheet-like product
40a Material composition
41 Casting machine
41a Head part
42a First gap holding member
42b Second gap holding member
43a Conveyance roll
43b Conveyance roll
44 Conveyance roll
45 Auxiliary roll
46 Heating device
47 Conveyor belt

### DESCRIPTION OF THE EMBODIMENTS

FIGS. 1 and 2 respectively illustrate a surface protection film according to an embodiment of the present invention, and a state in which the surface protection film according to an embodiment is adhered to a transparent substrate located on a surface of the display. In FIGS. 1 and 2, a thickness of each layer does not indicate the actual thickness.

A surface protection film 10 of the embodiment is obtained by laminating four layers, i.e., a protective layer 1 made of a polyurethane, a transparent base film 2, a blue light cutting layer 3, and an adhesive layer 4 in this order. Furthermore, the surface protection film 10 of the embodiment is adhered onto a transparent substrate 20 with the adhesive layer 4 therebetween.

In this way, since the surface protection film of the present invention is adhered to a surface of the transparent substrate, the surface protection film prevents the transparent substrate from being scratched, cracking, and becoming contaminated.

“Protective Layer”

A protective layer is made of a polyurethane. A polyurethane is obtained by causing a material composition containing at least a polyol and an isocyanate to react. The polyurethane used in the present invention is thermally cured as is apparent from the producing method described below in detail.

a. Polyol

Examples of the polyol include a polyether-based polyol, i.e., polyoxyalkylene glycols such as polyethylene glycol, polypropylene glycol, and polyoxytetramethylene glycol or alkylene oxide adducts such as those of ethylene oxide, or propylene oxide of bisphenol A, and glycerin; a polyester-based polyol obtained through a polymerization reaction between dibasic acids such as adipic acid, phthalic anhydride, isophthalic acid, maleic acid, and fumaric acid and glycols such as ethylene glycol, propylene glycol, 1,4-butanediol, 1,6-hexanediol, and trimethylolpropane; polycaprolactone polyols; polycarbonate polyols, and the like.

Among these, a polycarbonate-based polyol is desirable because then the obtained polyurethane has excellent swelling resistance and is prevented from swelling due to the transferring of a plasticizer due to contact with a rubber product or the like.

Examples of the polycarbonate-based polyol include a reaction product of a dialkyl carbonate and a diol. Furthermore, examples of the polycarbonate-based polyol include polycarbonate glycol, polycarbonate triol, polycarbonate tetraol, derivatives obtained by introducing side chains and branched structures thereto, modified products thereof, mixtures of these, and the like.

Examples of the dialkyl carbonate include dialkyl carbonates such as dimethyl carbonate and diethyl carbonate, diaryl carbonates such as diphenyl carbonate, alkylene carbonates such ethylene carbonate, and the like. Each of these may be used independently and a combination of two or more of these may be used.

Examples of the diol include 1,4-butanediol, diethylene glycol, 1,5-pentanediol, 1,6-hexanediol, 1,7-heptanediol, 1,8-octanediol, 2-methyl-1,8-octanediol, 1,9-nonanediol, 1,10-dodecanediol, 2-ethyl-1,6-hexanediol, 3-methyl-1,5-pentanediol, 2,4-dimethyl-1,5-pentanediol, neopentyl glycol, 1,3-cyclohexanediol, 1,4-cyclohexanediol, 1,4-cyclohexanedimethanol, 2,2′-bis(4-hydroxycyclohexyl)-propane, and the like. Each of these may be used independently and a combination of two or more of these may be used. As the diol, an aliphatic diol having 4 to 9 carbon atoms or an alicyclic diol are desirable. For example, it is desirable that 1,4-butanediol, diethylene glycol, 1,5-pentanediol, 1,6-hexanediol, 3-methyl-1,5-pentanediol, 2,4-dimethyl-1,5-pentanediol, 1,4-cyclohexanedimethanol, 1,7-heptanediol, 1,8-octanediol, 2-methyl-1,8-octanediol, and 1,9-nonanediol be used independently or a combination of two or more of these be used. Furthermore, diols having no branched structure are more desirable.

The number average molecular weight of the polyol is preferably 200 or more and 10,000 or less, more preferably 500 or more and 5,000 or less, and further more preferably 800 or more and 3,000 or less. When the number average molecular weight is less than 200, a reaction is too fast and the handleability is poor, and a molded body loses its flexibility and thus becomes brittle in some cases. On the other hand, when the number average molecular weight is more than 10,000, the viscosity is too high, the handleability is poor, and a molded body may become crystallized and thus become cloudy in some cases. In the present invention, the number average molecular weight refers to a molecular weight calculated from a hydroxyl value of a polyol measured in accordance with JIS K1557. Here, even if the number average molecular weight is outside of the above-mentioned numerical value range, the number average molecular weight is not excluded unless the number average molecular weight deviates from the gist of the present invention.

b. Isocyanate

Any isocyanate can be used without particular limitation as long as it has two or more isocyanate groups in a molecule. For example, tolylene diisocyanate, tolidine diisocyanate, diphenylmethane diisocyanate, polymethylene polyphenyl polyisocyanate, carbodiimidized diphenylmethane polyisocyanate, crude diphenylmethane diisocyanate, xylylene diisocyanate, 1,5-naphthalene diisocyanate, tetramethylxylene diisocyanate, isophorone diisocyanate, hydrogenated diphenylmethane diisocyanate, hydrogenated xylylene diisocyanate, hexamethylene diisocyanate, dimer acid diisocyanate, norbornene diisocyanate, and the like can be used. Two or more of these may be used in combination.

In the present invention, it is desirable that the polyurethane which forms the protective layer use an aliphatic isocyanate having no aromatic ring as an isocyanate component. A polyurethane obtained from an aliphatic isocyanate does not easily yellow and can prevent the polyurethane from discoloring due to light or heat from a light source, sunlight, and the like, thereby reducing transparency.

c. Alcohol-Based Curing Agent

The polyurethane which forms the protective layer of the present invention uses an alcohol-based curing agent as a curing agent. An alcohol-based curing agent has less adverse effects on the human body and the environment than an amine-based curing agent.

Any alcohol-based curing agent can be used without particular limitation as long as it has two or more hydroxy groups in a molecule. For example, dihydric alcohols such as ethylene glycol, 1,3-propanediol, 2-methyl-1,3-propanediol, 1,3-butanediol, 1,4-butanediol, 1,5-pentanediol, neopentyl glycol (2,2-dimethyl-1,3-propanediol), 1,6-hexanediol, polyethylene glycol, polypropylene glycol, polybutylene glycol, cyclohexanedimethanol, and hydrogenated bisphenol A, trihydric alcohols such as glycerin, trimethylolpropane, butanetriol, pentanetriol, hexanetriol, cyclopentanetriol, and cyclohexanetriol, and trihydric or higher alcohols such as pentaerythritol, dipentaerythritol, and tetramethylolpropane may be exemplified. Among these, it is desirable to use a dihydric alcohol and a trihydric alcohol together. When a large amount of trihydric alcohols is provided, the strength of the obtained polyurethane is reduced. Thus, it is desirable that an alcohol-based curing agent include 60 to 80 parts by weight of a dihydric alcohol and 40 to 20 parts by weight of a trihydric alcohol. As the dihydric alcohol, 1,4-butanediol is desirable and as the trihydric alcohol, trimethylolpropane is desirable in view of handleability and mechanical properties.

d. Catalyst

It is desirable that the polyurethane which forms the protective layer of the present invention be thermally cured in the presence of a non-amine catalyst. Using a non-amine catalyst, it is possible to obtain a polyurethane having excellent non-coloring property, transparency, and weather resistance. On the other hand, in a polyurethane obtained through thermal curing using an amine-based catalyst, outgoing light becomes yellow and an outer form becomes colored over time in some cases.

Examples of the non-amine catalyst include organotin compounds such as di-n-butyltin dilaurate, dimethyltin dilaurate, dibutyltin oxide, and octane tin, organic titanium compounds, organic zirconium compounds, carboxylic acid tin salts, and carboxylic acid bismuth salts, and the like. Among these, organotin compounds are desirable because they allow a reaction rate to be adjusted easily.

It is desirable that 0.0005 wt % or more and 3.0 wt % or less of the non-amine catalyst be added with respect to the total amount of a. to c. described above. When the non-amine catalyst is less than 0.0005 wt %, a reaction rate may not be sufficiently rapid and thus a molded body may not be able to be obtained efficiently. When the non-amine catalyst is more than 3.0 wt %, a reaction rate is too fast and thus problems in which it is not possible to obtain a molded body having a uniform thickness, heat resistance and weather resistance of the molded body are reduced, light transmittance decreases, and the molded body is colored occur in some cases. Here, even if the amount of non-amine catalyst to be added is outside of the above-mentioned numerical value range, the amount is not excluded unless the amount deviates from the gist of the present invention.

The polyurethane which forms the protective layer can contain various additives such as a colorant, a light stabilizer, a heat stabilizer, an antioxidant, an antifungal agent, a flame retardant, and a lubricant as necessary as long as the required characteristics are not impaired.

e. Silicone-Based Additive

In the surface protection film of the present invention, it is desirable that the polyurethane which forms the protective layer contain a silicone-based additive. Since the protective layer contains the silicone-based additive, it is possible to improve the slipperiness and to comfortably perform the touch panel operation using a touch pen, a finger, or the like. A lower limit of an amount of silicone-based additive to be added is preferably 0.05 wt % or more, more preferably 0.1 wt % or more, and further more preferably 0.3 wt % or more with respect to the total amount of a. to c. described above. Furthermore, an upper limit of an amount of silicone-based additive to be added is preferably 1.0 wt % or less, more preferably 0.9 wt % or less, and further more preferably 0.7 wt % or less with respect to the total amount of a. to c. described above. When an amount of silicone-based additive to be added is less than 0.05 wt %, the sufficient improvement of slipperiness is not provided in some cases. On the other hand, if the amount of silicone-based additive to be added is more than 1.0 wt %, the slipperiness becomes too good and thus the pen tip of a touch pen slips, resulting in poor writing sensation in some cases. Here, even if the amount of silicone-based additive to be added is outside of the above-mentioned numerical value range, the amount is not excluded unless the amount deviates from the gist of the present invention.

The silicone-based additive can be contained in the polyurethane by adding the silicone-based additive to the material composition in which the polyurethane is not thermally cured and thermally curing the material composition. Furthermore, it is desirable to use a non-reactive additive which does not form a covalent bond with a crosslinked network formed using a polyol, an isocyanate, and an alcohol-based curing agent as the silicone-based additive. Since the non-reactive silicone-based additive gradually bleeds out on a surface of the protective layer, it is possible to impart slipperiness over a long period of time. The silicone-based additive can be used without particular limitation as long as it is not subjected to phase separation from the material composition which is not subjected to thermal curing. For example, polyether-modified polydimethylsiloxane, polyaralkyl-modified polydimethylsiloxane, and long-chain alkyl-modified polydimethylsiloxane can be used. To be specific, it is possible to use commercially available products such as KF352A, KF615A, X22-4515, KF410, KF412, and the like manufactured by Shin-Etsu Chemical Co., Ltd.

The protective layer is a molded body made of a polyurethane obtained by curing a material composition containing at least a polyol, an isocyanate, and an alcohol-based curing agent in the presence of a catalyst. In addition, the molding method may be any one of a one-shot method, a prepolymer method, and a pseudo prepolymer method.

In the one-shot method, it is possible to prepare a molded body made of a polyurethane by inputting a polyol, an isocyanate, an alcohol-based curing agent, any additive, and a catalyst together and curing them.

In the prepolymer method, it is possible to prepare a molded body made of a polyurethane by preparing a prepolymer having an isocyanate group at a terminal in advance by causing a polyol and a stoichiometric excess of isocyanate to react, mixing a predetermined amount of alcohol-based curing agent, any additive, and a catalyst with the prepolymer, and curing the prepolymer.

In the pseudo prepolymer method, it is possible to prepare a molded body made of a polyurethane by mixing a part of a polyol with an alcohol-based curing agent in advance, preparing a prepolymer using the remaining polyol and an isocyanate, and mixing a mixture of a polyol, an alcohol-based curing agent, any additive, and a catalyst which have been mixed in advance with the prepolymer, and curing the mixture.

In the present invention, a ratio (—OH/—NCO: hereinafter referred to as an “a ratio”) between the number of moles of hydroxyl groups (—OH) contained in an alcohol-based curing agent and the number of moles of isocyanate groups (—NCO) of an isocyanate or a prepolymer in a material composition in which a polyurethane is not thermally cured is preferably 0.8 or more and 1.5 or less. When the a ratio is less than 0.8, mechanical properties are unstable. In addition, when the a ratio is more than 1.5, surface tackiness increases and good writing sensation deteriorates. Furthermore, the a ratio is more preferably 1.05 or more and 1.3 or less because then the polyurethane which constitutes the protective layer deforms appropriately and scratch resistance is improved.

Also, it is desirable that a polyurethane do not contain an acrylic skeleton (an acrylic skeleton or a methacrylic skeleton). That is to say, it is desirable that the polyurethane which forms the protective layer of the present invention do not contain an acrylic-modified polyurethane. A polyurethane having an acrylic skeleton impairs the flexibility of a polyurethane and reduces wear resistance and a mechanical strength such as tear strength in some cases. In addition, outgoing light is colored due to the residue of a catalyst used to introduce the acrylic skeleton or a methacrylic skeleton in some cases.

A thickness of the protective layer is preferably 50 μm or more and 300 μm or less, more preferably 100 μm or more and 200 μm or less. When the protective layer has a thickness of 50 μm or more and 300 μm or less, it is possible to obtain a surface protection film having very good writing sensation of a touch pen and slipperiness and excellent self-repairability. When the thickness of the protective layer is less than 50 μm, writing sensation and self-repairability are reduced. When the thickness of the protective layer is more than 300 μm, light transmittance, transparency, writing sensation, slipperiness, and self-repairability are reduced, and thus it is difficult to perform molding to have a uniform thickness. When the thickness of the protective layer is 50 μm or more and 300 μm or less, the performance required for the surface protection film is exhibited in a well-balanced manner and production is easy.

It is desirable that the protective layer be made of a polyacetal resin (POM) and have a dynamic friction coefficient of preferably 0.10 or more and 0.26 or less, more preferably 0.12 or more and 0.23 or less, and further more preferably 0.14 or more and 0.20 or less with respect to a touch pen whose tip shape is a hemisphere having a diameter of 1.4 mm. When the dynamic friction coefficient is less than 0.10, a touch pen slides too much, and when the dynamic friction coefficient is more than 0.26, the movement of a touch pen becomes heavy. It is possible to adjust the dynamic friction coefficient of the protective layer using the thickness of the protective layer, the a ratio of the polyurethane which forms the protective layer, the amount of silicone-based additive to be added, and the like. As a touch pen made of a polyacetal resin (POM) and having a tip shape of a hemisphere having a diameter of 1.4 mm, for example, a touch pen commercially available from WACOM can be used.

“Transparent Base Film”

A transparent base film holds a protective layer. A material constituting the transparent base film can be used without particular limitation as long as it has excellent transparency, flexibility, and mechanical strength and polyethylene terephthalate (PET), polyethylene naphthalate (PEN), polycarbonate (PC), cyclic olefin resin (COP), polyimide (PI), and the like can be suitably used as the material.

A thickness of the transparent base film is preferably 50 μm or more and 500 μm or less. In the surface protection film of the present invention, a thermal expansion coefficient of a polyurethane which forms the protective layer is usually larger than a thermal expansion coefficient of a material constituting the transparent base film. Thus, when the thickness of the transparent base film is less than 50 μm, the transparent base film is not sufficiently resistant to the shrinkage of the protective layer at low temperatures and the surface protection film peels off from the transparent substrate in some cases. When the thickness of the transparent base film is more than 500 μm, the surface protection film is bulky and the production costs thereof increases.

Furthermore, the operability using a touch pen or the like is reduced. Description will be provided in detail in the “method for producing the protective layer” which will be described later, but the protective layer can be formed directly above the transparent base film. When this producing method is used, in order to prevent deformation during heating when the material composition is thermally cured to form the protective layer, it is desirable that the transparent base film be thicker. Here, even if the thickness is outside of the above-mentioned numerical value range, the thickness is not excluded unless the thickness deviates from the gist of the present invention.

“Blue light cutting layer” A blue light cutting layer is a layer which cuts blue light which may adversely affect the eyes and specifically means a layer having a transmittance of light with a wavelength of 450 nm (hereinafter referred to as “blue light transmittance”) of 75% or less. The blue light cutting layer of the present invention is not particularly limited as long as the blue light transmittance is 75% or less, but is preferably a blue light cutting layer with little change in the color of the image projected onto a display. To be specific, the yellowness (YI) defined in JIS K7373 is preferably 15.0 or less, more preferably 10.0 or less, and even more preferably 5.0 or less.

The blue light cutting layer can be used without particular limitation as long as it has the above-mentioned optical characteristics. For example, it is possible to produce a blue light cutting layer by applying a curable resin composition containing at least a colorant which cuts blue light on the surface of the transparent base film opposite to the protective layer and curing the curable resin composition. Furthermore, the commercially available blue light cut film which has the blue light cutting layer formed above the base film can also be used as the transparent base film and the blue light cutting layer which can be placed on the surface protection film of the present invention. In this case, the protective layer is formed above the surface of the transparent base film opposite to the blue light cutting layer in the blue light cut film.

“Adhesive Layer”

An adhesive layer is used to adhere the surface protection film onto the transparent substrate of the surface of the display. A type of adhesive is not particularly limited and an adhesive made of an acrylic-based resin, an epoxy-based resin, a urethane-based resin, a silicone-based resin, or the like can be used. Among these, an adhesive made of an acrylic-based resin can be adhered to even a transparent substrate which has been subjected to surface treatment such as antifouling treatment and low reflection treatment. Furthermore, an adhesive made of a silicone-based resin has excellent wettability, hardly causes bubbles when adhered to the transparent substrate, has good re-peeling properties, and hardly any thereof remains at the time of peeling off. A thickness of the adhesive layer is usually in the range of 5 μm or more and 60 μm or less, but can be adjusted appropriately in accordance with the required specifications.

“Surface Protection Film”

A surface protection film 10 as an embodiment is obtained by laminating four layers, i.e., a protective layer 1 made of a polyurethane, a transparent base film 2, a blue light cutting layer 3, and an adhesive layer 4 in this order. The surface protection film of the present invention may be obtained by laminating at least the above-mentioned four layers in this order. For example, it is also possible to provide an intermediate layer configured to enhance adhesion between the layers.

In the surface protection film of the present invention, at least the transparent base film is present between the protective layer made of a polyurethane and the blue light cutting layer and the protective layer made of a polyurethane is not in contact with the blue light cutting layer. When the protective layer made of a polyurethane is directly formed above the blue light cutting layer, fine air bubbles are generated in the protective layer. This is because the moisture contained in the blue light cutting layer moves into the material composition in which the polyurethane is not thermally cured and this moisture reacts with an isocyanate to generate carbon dioxide gas. When the protective layer made of a polyurethane is directly formed above the water-repellent blue light cutting layer to prevent moisture migration, adhesion between the blue light cutting layer and the protective layer is poor and peeling occurs between the layers in some cases.

A haze value of the surface protection film is preferably 0.1% or more and 40% or less. Furthermore, the total light transmittance of the surface protection film is preferably 65% or more. When the haze value is larger than 40%, the visibility is reduced. In addition, when the total light transmittance is less than 65%, an image becomes too dark. When the haze value of the surface protection film is 0.1% or more and less than 3%, it is possible to obtain a clear outer form. When the haze value of the surface protection film is 3% or more and 40% or less, it is possible to impart the anti-glare properties to the surface of the protective film. Furthermore, in the surface protection film having anti-glare properties, it is hard to distinguish the damage on the surface of the protective layer. In order to make the surface protective film to have a haze value of 3% or more and 40% or less, unevenness may be formed in the surface of the protective layer. The uneven shape in the surface of the protective layer is not particularly limited as long as the uneven shape has the above-mentioned haze value and the total light transmittance, and may be appropriately adjusted in accordance with the refractive index, the light absorption, and the like of the material to be used, but usually has an average length (RSm) of a roughness curve element of about 10 μm or more and 80 μm or less. In addition, an arithmetic average roughness Ra is about 0.01 μm or more and 0.3 μm or less and a maximum height Rz is about 0.1 μm or more and 2.0 μm or less.

In order to protect the surface protection film as the present invention until it is adhered to the transparent substrate of the surface of the display, it is possible to make the surface protection film laminate by adhering a mold release film to a surface of the surface protection film on the protective layer side and a release film to the other surface thereof on the adhesive layer side. FIG. 3 illustrates a surface protection film laminate 30 obtained by adhering a mold release film 5 and a release film 6 to the surface protection film 10 of the embodiment. In FIG. 3, the thickness of each layer does not mean the actual thickness.

The mold release film is for the purpose of preventing the protective layer from becoming dirty, adhering of dust, and having scratches and it is desirable to use a film having a surface on a side to be adhered to the protective layer which has been subjected to mold release treatment. When the mold release film which has been subjected to mold release treatment is released from the protective layer, a mold release agent moves to the surface of the protective layer and can impart slipperiness to the surface of the protective layer immediately after the mold release film is released, and thus it is possible to perform a touch operation without a discomfort immediately after starting of using. Furthermore, description will be provided in detail in the “method for producing the protective layer” which will be described later, but the protective layer can be formed directly above the mold release film. In this case, in order to prevent deformation during heating when the material composition is thermally cured to form the protective layer, the mold release film is preferably 50 μm or more and 300 μm or less and more preferably thicker.

The release film protects the adhesive layer to prevent dirt, dust adhesion, a decrease in adhesive strength, and the like. The release film is not particularly limited and it is possible to appropriately use a film having a surface on a side to be adhered to the adhesive layer which has been subjected to mold release treatment.

“Method for Producing Protective Layer”

A protective layer can be produced using a polyurethane obtained by pouring a material composition which contains at least a polyol, an isocyanate (or a urethane prepolymer made of any of these), an alcohol-based curing agent, and a catalyst into a gap between first and second gap holding members sent out using pair of rolls spaced apart from each other, introducing the material composition into a heating device while the material composition is being held between the two gap holding members, and thermally curing the material composition.

FIG. 4 illustrates a schematic diagram of the method for producing the protective layer. The method for producing the protective layer will be described below using FIG. 4.

A material composition 40a is poured into a gap between first and second gap holding members 42a and 42b sent out using a pair of conveyance rolls 43a and 43b spaced apart from each other using a casting machine 41. The first and second gap holding members 42a and 42b are guided into a heating device 46 while the material composition 40a is being held therebetween. A sheet-like product 40 made of a polyurethane is produced by thermally curing the material composition 40a while the material composition 40a is being held between the first and second gap holding members 42a and 42b.

In FIG. 4, conveyance rolls configured to send out the first and second gap holding members 42a and 42b are denoted with 44, auxiliary rolls are denoted with 45, and a conveyor belt configured to convey the first and second gap holding members 42a and 42b having the material composition 40a held therebetween in the heating device 46 is denoted with 47.

The first and second gap holding members 42a and 42b can be used without particular limitation as long as they are materials which do not thermally deform when the material composition is thermally cured. For example, it is possible to use a long film made of a polymer material such as polyethylene terephthalate (PET), polyethylene naphthalate (PEN), polycarbonate (PC), cyclic olefin resin (COP), and polyimide (PI). Although a long film made of a polymer material is used for the gap holding members in the schematic diagram illustrated in FIG. 4, it is also possible to use an endless belt made of any of polymer materials or a metal material such as aluminum.

Since the first and second gap holding members 42a and 42b are pulled and conveyed with the same tension while holding the material composition 40a therebetween, the gap can be maintained to have a constant size. Since the material composition 40a is placed between the first and second gap holding members 42a and 42b and cured while a constant thickness is being maintained, the sheet-like product 40 having an excellent thickness accuracy is obtained. Using this producing method, it is possible to continuously form the sheet-like product 40 having a thickness of 50 μm or more which is difficult to be applied and having practical optical characteristics as a protective layer of the surface protection film.

It is desirable that a position of a head part 41a in the casting machine 41 be unevenly distributed toward one side of the conveyance rolls from a central portion of the conveyance rolls 43a and 43b (a central portion of the gap formed by the first and second gap holding members 42a and 42b) and it is desirable that an uneven distribution distance be equal to or less than a radius of the conveyance rolls. That is to say, it is desirable that a portion directly below the head part 41a in the casting machine 41 be located between a central portion of the pair of conveyance rolls 43a and 43b and a central axis of one of the conveyance rolls. Furthermore, a shortest distance between a tip portion of the head part 41a and surfaces of the conveyance rolls is preferably 5 cm or less. By arranging the head part 41a in this way, a thickness accuracy of the sheet-like product 40 is further improved, air bubbles are not easily mixed into the uncured material composition 40a poured into the gap between the first and second gap holding members 42a and 42b and the incorporated bubbles are easily removed.

The conveyance rolls 43a and 43b may simply have only a conveyance function, but it is desirable that the conveyance rolls 43a and 43b be heating rolls. When the conveyance rolls are heating rolls, it is possible to perform a curing reaction immediately after the material composition 40a is held in the gap between the first and second gap holding members 42a and 42b, to maintain a further uniform thickness until the material composition 40a is introduced into the heating device 46, and to form the sheet-like product 40 having better thickness accuracy. A conveyance surface temperature at the time of heating the conveyance rolls is set to 10 or more and 60° C. or less. When the conveyance surface temperature is less than 10° C., a viscosity of the material composition 40a increases and thus air bubbles are not easily removed and a rate of a curing reaction decreases and thus a thickness accuracy of the sheet-like product 40 decreases. When the conveyance surface temperature exceeds 60° C., the material composition 40a is cured on the conveyance rolls or air bubbles are input into the sheet-like product 40 in some cases.

The heating device 46 is a heating furnace which includes a heater and any heating device may be adopted as the heating device 46 as long as it can increase a temperature inside the furnace to a curing temperature of the material composition 40a. Furthermore, heating conditions (curing conditions) in the heating device 46 are not particularly limited, any heating conditions (curing conditions) may be adopted as the heating conditions (curing conditions) as long as they are appropriately set in accordance with a composition of the material composition 40a, and for example, the heating (curing) may be performed under conditions of 40° C. or more and 160° C. or less for 1 minute or more and 180 minutes or less.

A elongated laminate formed of the first gap holding member 42a, the sheet-like product 40 made of a polyurethane, and the second gap holding member 42b is unloaded from the heating device 46. Moreover, the sheet-like product 40 of the elongated laminate serves as the protective layer in the surface protection film of the present invention.

“Method for Producing Surface Protection Film Laminate”

In the above-mentioned producing method, it is possible to make one of the first gap holding member 42a and the second gap holding member 42b serve as the transparent base film in the surface protection film of the present invention. Furthermore, it is possible to make the other of the first gap holding member 42a and the second gap holding member 42b serve as the mold release film. A case in which the first gap holding member 42a serves as the transparent base film and the second gap holding member 42b serves as the mold release film will be described below as an example.

Using the above-mentioned producing method, the elongated laminate formed of the first gap holding member 42a serving as the transparent base film 2, the sheet-like product 40 made of a polyurethane serving as the protective layer 1, and the second gap holding member 42b serving as the mold release film 5 is unloaded. At this time, it is desirable that a film which has been not subjected to release treatment be used as the first gap holding member 42a and a film which is subjected to release treatment be used as the second gap holding member 42b.

Since the blue light cutting layer and the adhesive layer are formed on a surface of the elongated laminate on a first gap holding member 42a side using coating or the like and the release film is adhered above the adhesive layer, it is possible to obtain the long surface protection film laminate of the present invention. Furthermore, it is also possible to use, as the first gap holding member 42a, a laminate obtained by laminating a transparent base film/a blue light cutting layer in this order or a laminate obtained by laminating a transparent base film/a blue light cutting layer/an adhesive layer/a release film in this order. In addition, since the material composition 40a is held in a surface having unevenness using a film having unevenness as a second gap holding member 42b, it is possible to transfer unevenness to the outermost surface of the sheet-like product 40 of the protective layer and impart anti-glare properties to the obtained protective layer.

Using this producing method, it is possible to continuously produce the surface protection film laminate using so-called roll to roll processing. The produced surface protection film laminate has both surfaces having the mold release film and the release film and it is possible to prevent the surface protection film from being scratched, contaminated, or the like and has excellent handleability.

The surface protection film laminate may be rolled and shipped in a roll shape or may be shipped after being cut into a sheet shape. Furthermore, it is also possible to ship an elongated laminate formed of the first gap holding member 42a, the sheet-like product 40 made of a polyurethane, and the second gap holding member 42b or a sheet-like laminate obtained by cutting this elongated laminate, forming a blue light cutting layer and an adhesive layer through coating in a display factory or the like, and adhering the laminate to the transparent substrate of the display.

### EXAMPLES

While the present invention will be described below in more detail using examples, the present invention is not limited to these examples.

### Experiment 1

### “Example 1”

A material composition (an a ratio: 0.95) was prepared by adding, stirring, and mixing 59.4 g of poly(1,6-hexanecarbonate)diol (manufactured by Tosoh Corporation, product name: 980R) having a molecular weight of 2000 and a hydroxyl value of 55, 31.1 g of isophorone diisocyanate, 9.5 g of an alcohol-based curing agent having a weight ratio of 1,4-butanediol/trimethylolpropane=60/40, 150 ppm of an organotin compound, and 0.7 g of a silicone-based additive (manufactured by Shin-Etsu Chemical Co., Ltd., product name: KF615A).

A surface protection film laminate having a protective layer with a thickness of 150 μm above a PET base material was produced through the above-described molding method using a commercially available blue light cut film (manufactured by Nippa Corporation) obtained by laminating a release film, an adhesive layer, a blue light cutting layer, and a PET base material in this order as a first gap holding member and a PET film (corresponding to a mold release film) with a thickness of 125 μm which is subjected to silicone treatment as a second gap holding member.

### Comparative Example 1

A surface protection film laminate having a protective layer with a thickness of 150 μm above a blue light cutting layer was produced in the same manner as in Example 1 except that a commercially available blue light cut film (manufactured by Nippa Corporation) obtained by laminating a release film, an adhesive layer, a PET base material, and a blue light cutting layer in this order was used as a first gap holding member.

### Comparative Example 2

A surface protection film laminate having a protective layer with a thickness of 150 μm above a blue light cutting layer having water repellency was produced in the same manner as in Example 1 except that a commercially available blue light cut film (manufactured by Nippa Corporation) obtained by laminating a release film, an adhesive layer, a PET base material, and a blue light cutting layer having water repellency in this order was used as a first gap holding member.

The following evaluation was performed on the surface protection film laminates manufactured by Example 1 and Comparative Examples 1 and 2. The results are shown in Table 1.

### Outer Form

∘: The entire surface protection film laminate is uniform and can be used as an optical film.

x: The surface protection film laminate cannot be used as an optical film due to air bubbles, unevenness, cloudiness, and the like.

### Haze and Total Light Transmittance

A 5 cm square sample was cut from a created surface protection film laminate, a mold release film and a release film were released, the sample was set so that a surface thereof on a protective layer side was present on a light source side, and measurement was performed using a haze meter (manufactured by NIPPON DENSHOKU INDUSTRIES Co., LTD, device name: NDH7000 (CU-II specification)).

### Rotary Writing Test

A 10 cm square sample was cut from the created surface protection film laminate, a mold release film and a release film were released, and an exposed adhesive layer was adhered to a testing stand. A small amount of silicone spray (manufactured by ICHINEN CHEMICALS Co., LTD., Silicone spray 400, Ingredient: dimethyl silicone oil) was sprayed to a surface of a protective layer made of a polyurethane and then a counterpart member was brought into contact with the protective layer and rotated 10,000 times under the following conditions and the film laminate which has been subjected to the test was visually evaluated in the following criteria.

Counterpart member: POM (tip shape: hemispherical shape with diameter of 1.4 mm manufactured by WACOM)

Load: 500 g

Number of revolutions: 20 rpm

Distance from center of rotation: 3 cm

∘: No change in outer form is seen

x: Scratches, discoloration, delamination, and the like are seen

TABLE 1

| | | Haze | Total light | Rotary writing |
|---|---|---|---|---|
| | Outer form | (%) | transmittance (%) | test |
| Example 1 | ∘ | 3.1 | 73.0 | ∘ |
| Comparative | x | 2.6 | 85.7 | ∘ |
| Example 1 | Fine air | | | |
| | bubbles | | | |
| Comparative | ∘ | 11.5 | 88.7 | x |
| Example 2 | | | | Delamination |

In the surface protection film of Comparative Example 1, fine air bubbles having a diameter of about 0.5 mm were visible in the protective layer. This is because the moisture in the blue light cutting layer moves into the material composition in which the polyurethane which forms the protective layer was not cured and carbon dioxide gas was generated due to the reaction between isocyanate and water.

The surface protection film of Comparative Example 2 had a uniform outer form. However, as the results of the rotary writing test, delamination occurred between the blue light cutting layer and the protective layer. This is because the blue light cutting layer used in Comparative Example 2 had water repellency, but this water repellency is derived from a fluorine-based material. Thus, this is because the surface energy of the blue light cutting layer is low and the adhesiveness with the protective layer made of a polyurethane is low.

On the other hand, the surface protective film of Example 1 as the present invention had a uniform outer form and had excellent durability.

### Experiment 2

A surface protection film laminate was produced in the same manner as in Example 1 except that the thickness of the protective layer, the amount of silicone-based additive, and the a ratio were changed into the values shown in Table 2. In any of the surface protection film laminates, fine air bubbles were not generated in the protective layer.

A 15 cm×5 cm sample was cut from a produced surface protection film laminate, a mold release film and a release film were released, and an exposed adhesive layer was adhered to a moving stand of a surface property measuring instrument. A dynamic friction coefficient on the protective layer side was measured three times under the following conditions and an average value was determined. The results are shown in Table 2.

Surface property measuring instrument (manufactured by SHINTO Scientific Co., Ltd., device name: TYPE14)

Load: 200 g

Speed: 10 mm/sec

Counterpart material: POM (tip shape: hemispherical shape with diameter of 1.4 mm manufactured by WACOM)

Angle: 60 degrees

Temperature: 23±3° C.

Humidity: 35±10%

Dynamic friction coefficient: average value at the time of moving by 10 cm

TABLE 2

| | Example | Example | Example | Example | Example | Example | Example |
|---|---|---|---|---|---|---|---|
| | 2 | 3 | 4 | 5 | 6 | 7 | 8 |
| Thickness | 200 | 200 | 200 | 200 | 150 | 150 | 150 |
| (μm) | | | | | | | |
| Amount of | 0 | 0 | 0.3 | 0.5 | 0.3 | 0.5 | 0.7 |
| silicone | | | | | | | |
| (phr) | | | | | | | |
| α ratio | 0.90 | 1.10 | 1.10 | 1.10 | 1.10 | 1.05 | 0.95 |
| Dynamic | 0.10 | 0.26 | 0.21 | 0.21 | 0.22 | 0.23 | 0.17 |
| friction | | | | | | | |
| coefficient | | | | | | | |

The surface protection films produced in Examples 2 to 8 had writing sensation as if writing is performed on paper with a pencil during an operation with a touch pen. Among these, the surface protection films produced in Examples 4 to 8 were excellent in writing sensation and surface protection film produced in Example 8 was particularly excellent.

1. A surface protection film, comprising:
at least four layers of a protective layer made of a polyurethane, a transparent base film, a blue light cutting layer, and an adhesive layer laminated in this order.

2. The surface protection film according to claim 1, wherein the polyurethane is a polycarbonate-based polyurethane.

3. The surface protection film according to claim 1,
wherein the polyurethane is a cured product of a material composition which contains a polycarbonate-based polyol, an isocyanate, and an alcohol-based curing agent.

4. The surface protection film according to claim 1, wherein the protective layer has a dynamic friction coefficient of 0.10 or more and 0.26 or less with respect to a touch pen made of a polyacetal resin and having a hemispherical tip shape with a diameter of 1.4 mm.

5. The surface protection film according to claim 1, wherein the polyurethane contains a silicone-based additive.

6. The surface protection film according to claim 1, wherein the protective layer has a thickness of 50 μm or more and 300 μm or less.

7. A surface protection film laminate, comprising:
a mold release film laminated on a surface of the surface protection film according to claim 1 on the protective layer side; and
a release film laminated on a surface thereof on the adhesive layer side.

8. A method for producing a surface protection film having at least four layers of a protective layer made of a polyurethane, a transparent base film, a blue light cutting layer, and an adhesive layer laminated in this order, comprising:
pouring a material composition into a gap between first and second gap holding members sent out using pair of rolls spaced apart from each other;
thermally curing the material composition while the material composition is being held between the first and second gap holding members to produce the protective layer; wherein
one of the first and second gap holding members is at least the transparent base film.

9. The method for producing a surface protection film according to claim 8, wherein one of the first and second gap holding members as a transparent base film has a blue light cutting layer.

10. The method for producing a surface protection film according to claim 8, wherein the polyurethane is a polycarbonate-based polyurethane.

11. The method for producing a surface protection film according to claim 8, wherein the material composition comprises a silicone-based additive.

12. The method for producing a surface protection film according to claim 9, wherein the polyurethane is a polycarbonate-based polyurethane.

13. The method for producing a surface protection film according to claim 9, wherein the material composition comprises a silicone-based additive.

14. The method for producing a surface protection film according to claim 10, wherein the material composition comprises a silicone-based additive.

15. The surface protection film according to claim 2, wherein the polyurethane is a cured product of a material composition which contains a polycarbonate-based polyol, an isocyanate, and an alcohol-based curing agent.

16. The surface protection film according to claim 2, wherein the protective layer has a dynamic friction coefficient of 0.10 or more and 0.26 or less with respect to a touch pen made of a polyacetal resin and having a hemispherical tip shape with a diameter of 1.4 mm.

17. The surface protection film according to claim 3, wherein the protective layer has a dynamic friction coefficient of 0.10 or more and 0.26 or less with respect to a touch pen made of a polyacetal resin and having a hemispherical tip shape with a diameter of 1.4 mm.

18. The surface protection film according to claim 2, wherein the polyurethane contains a silicone-based additive.

19. The surface protection film according to claim 3, wherein the polyurethane contains a silicone-based additive.

20. The surface protection film according to claim 2, wherein the protective layer has a thickness of 50 μm or more and 300 μm or less.
